(19) United States
(12) Patent Application Publication
(10) Pub. No.: US 2017/0155523 A1
(43) Pub. Date: Jun. 1, 2017

(54) METHOD AND APPARATUS FOR IDENTIFYING TYPE OF ELECTRONIC DEVICE ON SMART SOCKET, AND STORAGE MEDIUM

(71) Applicant: XIAOMI INC., Beijing (CN)

(72) Inventors: Qiang FU, Beijing (CN); Li LI, Beijing (CN); Enxing HOU, Beijing (CN)

(73) Assignee: XIAOMI INC., Beijing (CN)

(21) Appl. No.: 15/293,053

(22) Filed: Oct. 13, 2016

(30) Foreign Application Priority Data
Nov. 30, 2015 (CN) 201510860209.X

(51) Int. Cl. H04L 12/28; H01R 13/66; H01R 25/00; H04L 29/08

(52) U.S. Cl. CPC H04L 12/2807; H04L 67/12; H04L 67/10; H04L 12/2818; H01R 13/6683; H01R 25/003

(57) ABSTRACT

The present disclosure relates to a method and an apparatus for identifying a type of an electronic device on a smart socket. The method includes: obtaining a target power-on state parameter of a target electronic device connected to the smart socket in a power-on state, identifying a target type of the target electronic device based on the target power-on state parameter, and outputting the target type.

### CROSS REFERENCE TO RELATED APPLICATION

This application is based on and claims priority of Chinese Patent Application No. 201510860209.X, filed on Nov. 30, 2015, which is incorporated herein by reference in its entirety.

### TECHNICAL FIELD

The present application generally relates to the field of smart home, and more particularly, to a method and apparatus for identifying a type of an electronic device on a smart socket.

### BACKGROUND

With the development of smart home, there are various target electronic devices that can access wireless networks and can be controlled to be on/off by a control device. For accurate on/off control of various target electronic devices, smart sockets have emerged as a simple and useful smart home devices. A smart socket is a socket having certain communication and processing capabilities. When a smart socket has accessed a wireless network, a user can control the smart socket to be powered on/off remotely using a control device, such as a mobile phone, thereby controlling an operation state of a target electronic device connected to the smart socket. However, since there are various types of electronic devices that may correspond to a number of smart sockets, when controlling a socket to be powered on/off, a user may control another socket corresponding to another electronic device by mistake due to lack of knowledge about the type of the target electronic device corresponding to the smart socket.

### SUMMARY

According to a first aspect of the present disclosure, a method for identifying a type of an electronic device on a smart socket is provided. The method may include: obtaining a target power-on state parameter of a target electronic device connected to the smart socket in a power-on state, identifying a target type of the target electronic device based on the target power-on state parameter, and outputting the target type. According to a second aspect of the present disclosure, an apparatus for identifying a type of an electronic device on a smart socket is provided. The apparatus comprises: a parameter obtaining unit configured to obtain a target power-on state parameter of a target electronic device connected to the smart socket and in a power-on state; a type identification unit configured to identify a target type of the target electronic device based on the target power-on state parameter obtained by the parameter obtaining unit; and a type output unit configured to output the target type identified by the type identification unit.

According to a third aspect of the present disclosure, an apparatus for identifying a type of an electronic device on a smart socket is provided. The apparatus may include: a processor, and a memory storing instructions executable by the processor. The processor may be configured to: obtain a target power-on state parameter of a target electronic device connected to the smart socket in a power-on state, identify a target type of the target electronic device based on the target power-on state parameter, and output the target type.

According to a fourth aspect of the present disclosure, there is provided a non-transitory computer-readable storage medium having stored instructions for identifying a type of an electronic device on a smart socket, wherein the instructions, when executed by a processor of a mobile terminal, cause the mobile terminal to: obtain a target power-on state parameter of a target electronic device connected to the smart socket in a power-on state, identify a target type of the target electronic device based on the target power-on state parameter, and output the target type.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate examples consistent with the disclosure and, together with the description, serve to explain the principles of the disclosure.

FIG. 1A is a flowchart illustrating a method for identifying a type of an electronic device on a smart socket according to an exemplary embodiment of the present disclosure;

FIG. 1B is a schematic diagram showing an application scenario in which a method for identifying a type of an electronic device on a smart socket according to an exemplary embodiment of the present disclosure can be applied;

FIG. 1C is a schematic diagram showing how to output target types on a smart device according to an exemplary embodiment of the present disclosure;

FIG. 1D is another schematic diagram showing how to output target types on a smart device according to an exemplary embodiment of the present disclosure;

FIG. 1E is a schematic diagram showing how to output target types on a smart socket according to an exemplary embodiment of the present disclosure;

FIG. 1F is a schematic diagram showing a prompt interface according to an embodiment of the present disclosure;

FIG. 2 is a block diagram of an apparatus for identifying a type of an electronic device on a smart socket according to an exemplary embodiment of the present disclosure;

FIGS. 3-10 are block diagrams of another apparatus for identifying a type of an electronic device on a smart socket according to an exemplary embodiment of the present disclosure;

FIG. 11 is a block diagram of an apparatus for identifying a type of an electronic device on a smart socket according to an exemplary embodiment of the present disclosure; and

FIG. 12 is a block diagram of another apparatus for identifying a type of an electronic device on a smart socket according to an exemplary embodiment of the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples of the present application. Also, common but well-understood elements that are useful or necessary in a commercially feasible example are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION

Reference will now be made in detail to certain examples, examples of which are illustrated in the accompanying drawings. The following description refers to the accompanying drawings in which the same numbers in different figures represent the same or similar elements unless otherwise indicated. The implementations set forth in the following description of examples do not represent all implementations consistent with the disclosure. Instead, they are merely examples of apparatuses and methods consistent with aspects related to the disclosure as recited in the appended claims.

The terms used herein are for the purpose of illustrating the examples only, rather than limiting the present disclosure. The terms “a,” “said” and “the” of singular forms used in the present description and the attached claims are also intended to include their plural forms, unless otherwise specified in the context. It can also be appreciated that the term “and/or” as used herein refers to any or all possible combinations of one or more associated items as listed.

It can be appreciated that, while the terms “first,” “second,” “third” and so on may be used herein to describe various information, such information is not limited to these terms, which are only used to distinguish between different information of the same category. For example, the first information can also be referred to as the second information, and similarly the second information can also be referred to as the first information, without departing from the scope of the present disclosure. Depending on the context, the term “if” as used herein can be interpreted as “when,” “while,” or “in response to determining”.

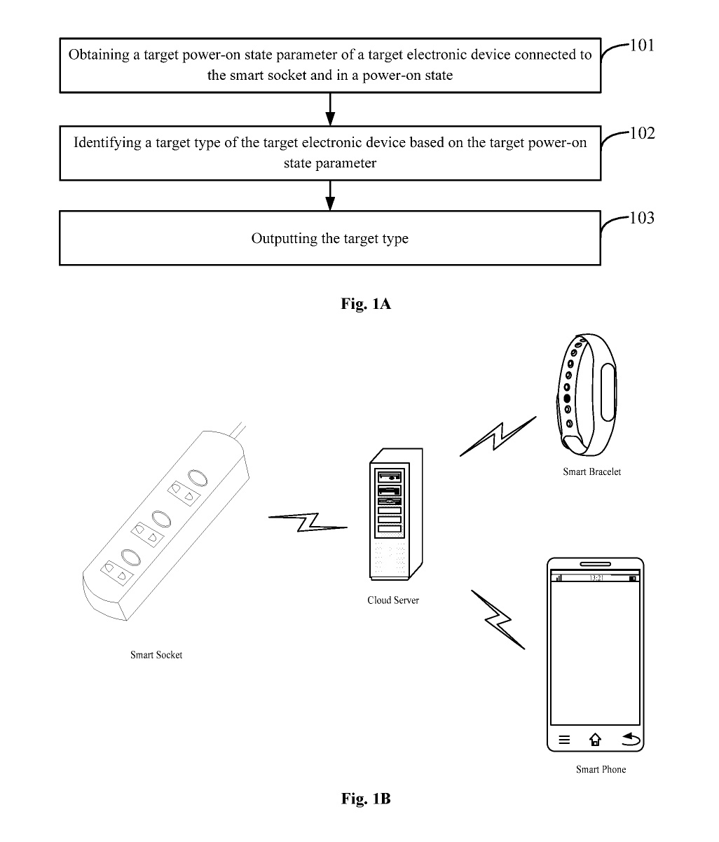

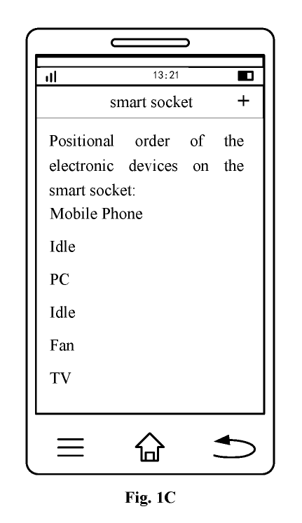

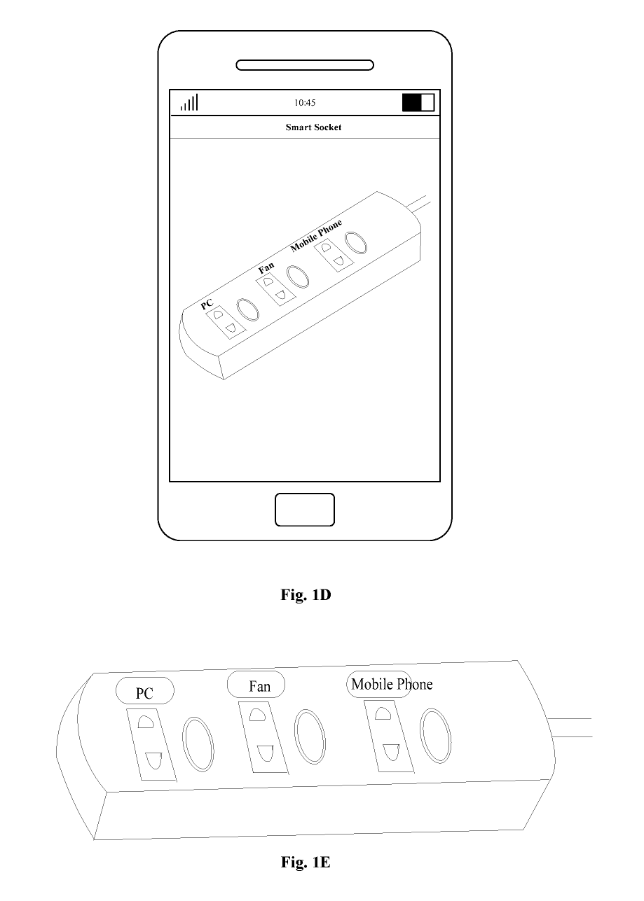

FIG. 1A is a flowchart illustrating a method for identifying a type of an electronic device on a smart socket according to an exemplary embodiment of the present disclosure. As shown in FIG. 1A, the method includes the following steps.

At step 101, a target power-on state parameter of a target electronic device connected to the smart socket in a power-on state is obtained.

At step 102, a target type of the target electronic device is identified based on the target power-on state parameter.

At step 103, the target type is outputted.

According to this example, a target power-on state parameter of a target electronic device connected to the smart socket in a power-on state is obtained. A target type of the target electronic device is identified based on the target power-on state parameter. Then, the target type is outputted.

In this way, a user can obtain a corresponding relationship between the smart socket and the target electronic device based on the outputted target type information. The user may control the smart socket connected with the target electronic device based on the corresponding relationship. By this way, controlling a socket corresponding to another electronic device by mistake due to lack of knowledge about the corresponding relationship between the target electronic device and the smart socket may be avoided.

The smart socket involved in the present disclosure can be a socket with or without a wireless communication capability. The socket is a base which one or more electrical wires can be inserted into. It may include one or more receptacles that can be connected to plugs of different target electronic devices for electrically connected with the target electronic devices. A smart socket is a socket having communication and processing capabilities. When the smart socket has a wireless communication capability, it can communicate with a smart device which can control the power on/off of the smart socket remotely. The smart device in the present disclosure can be a smart phone, a tablet computer, a Personal Digital Assistant (PDA), a smart bracelet, an e-book reader, or the like.

The smart socket and the smart device can communicate with each other directly. For example, the smart socket can serve as an access point and the smart device can search for the access point for connection to the smart socket. As another example, the smart device can serve as an access point and the smart socket can search for the access point for connecting to the smart device. Alternatively, the smart socket can communicate with the smart device via a server. In this case, the smart socket can transmit information to the server, which can then push the information to the smart device for outputting.

FIG. 1B is a schematic diagram showing an application scenario in which a method for identifying a type of an electronic device on a smart socket according to an exemplary embodiment of the present disclosure can be applied. In FIG. 1B, the server can be a cloud server and the smart socket can transmit the target power-on state parameter to the cloud server. The cloud server can push the target type to smart devices based on the target power-on state parameter, such that the smart devices, which can be a smart phone, a smart band and the like, can output the target type.

In FIG. 1B, the smart device is connected to the smart socket via the server, the method according to the present disclosure can be used in the server.

On one hand, the server may obtain a target power-on state parameter of a target electronic device connected to the smart socket in a power-on state, identify a target type of the target electronic device based on the target power-on state parameter, and transmit a corresponding relationship between the target type and the smart socket to the smart device, so as to control the smart device to output the corresponding relationship between the target type and the smart socket. The smart device can be a control terminal of the smart socket.

In this example, the server can identify the target electronic device on the smart socket to determine the target type of the target electronic device connected to the smart socket, and then push the corresponding relationship between the target type and the smart socket to smart devices, so as to control the smart devices to output the corresponding relationship between the target type and the smart socket. In this way, it is convenient for the user to control the on/off state of the smart socket based on the corresponding relationship via the smart devices, thereby controlling the power on/off state of the target electronic device.

When there are a large number of smart devices and a large number of smart sockets, the server can identify the target electronic devices on the respective smart sockets uniformly and push the identification results to the respective smart devices for presentation. Thus, uniform identification can be performed, efficiency can be achieved, resources can be saved and it is easy to implement.

There are a number of schemes for the server to control a smart device to output the corresponding relationship between the target type and the smart socket. Some of the schemes are explained here.

In a first scheme, when there are a number of receptacles in the smart socket, the server can control the smart device to output the target type in accordance with a positional rank of the electronic device on the smart socket. When there is a receptacle in the smart socket that is not connected to any electronic device, “Idle” information can be outputted.

FIG. 1C is a schematic diagram showing how to output target types on a smart device according to an exemplary embodiment of the present disclosure. In the example shown in FIG. 1C, “Mobile Phone, Idle, PC, Idle, Fan, TV” are outputted in accordance with the positional order of these electronic devices on the smart socket.

The socket can include a number of independently controlled receptacles, i.e., the on/off of each receptacle can be controlled separately.

In this example, the server can control the smart device to output the target type in accordance with a positional rank of the electronic device on the smart socket. In this way, the corresponding relationship between a receptacle and the target type can be obtained and the user can control the smart socket connected with the target electronic device based on the corresponding relationship, thereby avoiding the situation where the plug for the target electronic device cannot be identified when a number of target electronic devices are connected to the socket.

In a second scheme, the server can control the smart device to output the target type at a corresponding position on a virtual socket image, where the virtual socket image is a virtual image of the socket generated by the smart device.

When the smart socket includes a number of receptacles, each receptacle has a unique corresponding position and different receptacles can be distinguished from each other based on their corresponding positions. For example, each receptacle may have its corresponding position located above that receptacle. When there is only one receptacle on the smart socket, the corresponding position can be a position corresponding to the smart socket.

FIG. 1D is another schematic diagram showing how to output target types on a smart device according to an exemplary embodiment of the present disclosure. In the example shown in FIG. 1D, the target types, such as “PC”, “Fan” and “Mobile Phone”, are displayed above the corresponding virtual receptacles. The plugs of the electronic devices connected to the smart socket are omitted in FIG. 1D for simplicity.

It can be seen from the above example that the type of the electronic device connected to each receptacle can be identified.

In a third scheme, the server can control the smart device to output the target type at a name position corresponding to the smart socket.

The smart socket can be a socket having only one receptacle.

The user may name each smart socket manually as desired, e.g., sequentially as “Socket #1”, “Socket #2”, “Socket #3”, or in accordance with the names of the electronic devices by viewing the connected electronic devices.

Once the type of the target electronic device connected to the smart socket has been identified, the target type can be automatically outputted at a name position corresponding to the smart socket by the smart device. In this way, it is possible to name the smart socket with an improved naming efficiency. Meanwhile, it is convenient for the user to distinguish between different electronic devices connected to different smart sockets based on the names.

It can be appreciated that the scheme for the smart socket to output the target type is not limited to those described above. Other outputting schemes capable of representing the corresponding relationship between the target type and the smart socket may fall into the protection scope of the present disclosure and the details thereof are omitted here.

The server may obtain a target power-on state parameter of a target electronic device connected to the smart socket in a power-on state, identify a target type of the target electronic device based on the target power-on state parameter, and transmit a corresponding relationship between the target type and the smart socket to the smart socket, so as to output the target type via an output component provided in the smart socket. The output component is provided at a position corresponding to a connection position at which the target electronic device is connected to the smart socket.

There may be one-to-one corresponding relationships between the positions of the output components and the connection positions, such that different target electronic devices connected to the smart socket can be distinguished from each other via the output components.

FIG. 1E is a schematic diagram showing how to output target types on a smart socket according to an exemplary embodiment of the present disclosure. In the example shown in FIG. 1E, “PC”, “Fan” and “Mobile Phone” are outputted via the output components. The plugs of the electronic devices are omitted in FIG. 1E for simplicity.

In either a scenario where the smart device and the smart socket are in short range communication with each other or a scenario where the smart device and the smart socket are in remote communication with each other via a server, the method according to the present disclosure can be used in the smart device. The smart device can obtain a target power-on state parameter of a target electronic device connected to the smart socket in a power-on state, identify a target type of the target electronic device based on the target power-on state parameter, and output the target type.

The smart socket is a socket associated with the smart device, i.e., there is a binding relationship between them. The smart device can control the smart socket. The manner in which the smart device directly outputs the target type is similar to the above-described manner in which the server controls the smart socket to output the target type, and the details thereof are omitted here.

In this example, the smart device can identify the type of the target electronic device on the smart socket to determine the target type of the target electronic device connected to the smart socket, and output the corresponding relationship between the smart socket and the target electronic device.

In this way, it is convenient for the user to control the on/off state of the smart socket via the smart device based on the corresponding relationship between the smart socket and the target electronic device, thereby controlling the power on/off state of the target electronic device. Particularly, when there are a large number of smart sockets, the smart device can identify the target electronic devices on the respective smart sockets uniformly. Thus, uniform identification can be performed, efficiency can be achieve, resources can be saved and it is easy to implement.

In a scenario where the smart device and the smart socket are in short range communication with each other, a scenario where the smart device and the smart socket are in remote communication with each other via a server, or a scenario where the smart socket does not have a communication capability, the method according to the present disclosure can be used in the smart socket having a processing capability. The smart socket can obtain a target power-on state parameter of a target electronic device connected to the smart socket in a power-on state, identify a target type of the target electronic device based on the target power-on state parameter, and output the target type.

On one hand, the target type can be outputted via an output component provided in the smart socket. The output component can be provided at a position corresponding to a connection position at which the target electronic device is connected to the smart socket.

In this example, the type of the target electronic device can be displayed on the smart socket to inform the user of the target electronic device plugged into the socket. Particularly, when there are a number of receptacles on the sockets, determining the identity of the target electronic device corresponding to each receptacle allows the user to distinguish between different target electronic devices corresponding to different receptacles, thereby avoiding operating a receptacle corresponding to an unintended electronic device by mistake due to similarity of plugs of the target electronic devices.

On the other hand, the smart socket can identify the type of the target electronic device connected to it, determine the target type of the target electronic device connected to the smart socket, and then push the corresponding relationship between the smart socket and the target type to smart devices, so as to output the corresponding relationship between the smart socket and the target type via the smart devices.

In this way, it is convenient for the user to control the on/off state of the smart socket based on the corresponding relationship via the smart devices, thereby controlling the power on/off state of the target electronic device. Particularly, when there are a large number of smart devices and a small number of smart sockets, the smart socket can identify the target electronic device connected to it and push the identification result to the respective smart devices. In this way, efficiency can be achieved and resources can be saved.

In the following, examples will be given to explain the steps 101 through 103, respectively.

For the step 101, the target electronic device connected to the smart socket is an electronic device plugged into a receptacle of the smart socket. When the target electronic device is in the power-on state, a target power-on state parameter will be generated. For example, the target power-on state parameter can be one or more parameters for one or more of a target electrical power, a target power-on time, a target power-on time length and an electrical power stability.

The target power-on state parameter as used herein is a power-on state parameter to indicate the power is on. The target power-on state parameter is named so in order to be distinguishable from the power-on state parameter in the corresponding relationship table as described later.

The target electrical power is an electrical power of the target electronic device in the power-on state. The smart socket may have a built-in electrical power meter which can be used to measure the power usage of the target electronic device plugged into the smart socket. On one hand, the smart socket can identify the target type of the target electronic device corresponding to the smart socket based on the obtained electrical power directly. On the other hand, the server or the smart device can obtain from the electrical power meter in the smart socket the electrical power of the target electronic device connected to the smart socket and in the power-on state, and identify the target type of the target electronic device corresponding to the smart socket based on the target power-on state parameter.

The target power-on time may be the power-on start time or a power-on time period of the target electronic device. The smart socket may have a built-in timer.

In an optional implementation, the power-on start time can be recorded at the time when the target electronic device on the smart socket is powered on. On one hand, the smart socket can identify the type of the target electronic device on the smart socket based on the obtained power-on start time. On the other hand, the start time can be sent to the server or the smart device, such that the server or the smart device can identify the type of the target electronic device on the smart socket based on the start time.

In another optional implementation, the power-on start time and the power-on end time can be recorded while the target electronic device on the smart socket is powered on, so as to derive a power-on time period. On one hand, the smart socket can identify the type of the target electronic device on the smart socket based on the obtained power-on time period. On the other hand, the power-on time period can be sent to the server or the smart device, such that the server or the smart device can identify the type of the target electronic device on the smart socket based on the power-on time period.

Additionally or alternatively, the server or the smart device may be provided with a built-in timer. When the target electronic device on the smart socket is powered on, a power-on message is sent to the server or the smart device, such that the server and the smart device can determine the power-on start time of the target electronic device based on the time at which the power-on message is received. When the target electronic device on the smart socket is powered off, a power-off message is sent to the server or the smart device, such that the server and the smart device can determine the power-on end time of the target electronic device based on the time at which the power-off message is received. In this way, the power-on start time or the power-on time period can be obtained.

For the electrical power stability parameter, the target electrical power parameter of the target electronic device connected to the smart socket and in the power-on state can be obtained during a predetermined time period, and the electrical power stability parameter of the target electronic device can be determined based on the target electrical power parameter.

For the step 102, the target type as used herein is the type of the target electronic device, which is named so in order to be distinguishable from the type in the corresponding relationship table as described later. The target type can be the type of the target electronic device, which is a category to which the target electronic device belongs, such as refrigerator category, TV category, computer category, or the like.

In this step, corresponding relationships between power-on state parameters and respective electronic device types can be pre-established, so as to generate a target corresponding relationship table containing corresponding relationships between the power-on state parameters and the respective electronic device types. Once the target power-on state parameter has been obtained, the target type corresponding to the target power-on state parameter can be determined based on the target corresponding relationship table.

In this example, the target type corresponding to the target power-on state parameter can be determined based on the predetermined corresponding relationships between the power-on state parameters and the respective electronic device types.

Several schemes for determining the target type will be given below.

In a first scheme, the target type corresponding to the target electrical power parameter can be determined based on a first corresponding relationship table containing corresponding relationships between electrical power parameters and respective electronic device types.

In this scheme, the target power-on state parameter is a target electrical power parameter and a first corresponding relationship table can be set in advance. The first corresponding relationship table contains corresponding relationships between different electrical power parameters and respective electronic device types. The electrical power parameter can be a specific electrical power value or an electrical power range. Each electrical power value or range corresponds to an electronic device type. The corresponding relationship between the electrical power parameters and the respective electronic device types can be obtained.

Once the target electrical power parameter has been obtained, it is determined whether the target electrical power parameter matches an electrical power value or lies in an electrical power range in the first corresponding relationship table. If so, the electronic device type corresponding to the electrical power value or the electrical power range can be found and the target type of the target electronic device can be determined as the electronic device type.

It can be seen from the above example that the target electronic device can be identified based on the fact that different target electronic devices have different electrical powers.

In a second scheme, the target electrical power parameter of the target electronic device connected to the smart socket and in the power-on state can be obtained during a predetermined time period. The electrical power stability parameter of the target electronic device can be determined based on the target electrical power parameter. The target type corresponding to the electrical power stability parameter can be determined based on a second corresponding relationship table containing corresponding relationships between electrical power stability parameters and respective electronic device types.

The electrical power stability parameter is a parameter representing an electrical power stability state of the target electronic device. The electrical power stability parameter may include a state identifier (e.g., “1” indicating a stable state and “0” indicating an unstable state) and a target electrical power parameter.

In this scheme, the target power-on state parameter is the target electrical power parameter and the predetermined time period can be a predefined time length, such as 5 or 10 minutes. It can be determined whether the target electrical power is stable or not based on the variation of the target electrical power parameter within the predetermined time period. The target electrical power is stable if it remains constant. The target electrical power is unstable if it varies. For example, for home appliances, a target electronic device such as an air conditioner may have its power varying over time in operation.

It can be seen from the above example that the target electronic device can be identified based not only on the fact that different target electronic devices have different electrical powers, but also on the fact that the different target electronic devices have different electrical power stability states, thereby providing an improved identification accuracy. Particularly, when different target electronic devices have the same electrical power but different electrical power stability states, the target type corresponding to the electrical power stability parameter can be determined based on the predetermined second corresponding relationship table.

In a third scheme, the target type corresponding to the target power-on time parameter can be determined based on predetermined corresponding relationships between power-on time parameters and respective electronic device types.

The target power-on state parameter is the target power-on time parameter, which can be a power-on start time or a power-on time period of the target electronic device. For home appliances, different target electronic devices may have different power-on time parameters. For example, when the target power-on time parameter is the power-on time period, a kitchen ventilator may have predetermined power-on time periods of 7:00 to 8:00, 11:00 to 12:00 and 17:30 to 18:30. An electric light may have a predetermined power-on time period of 18:00 to 24:00. The specific time can be set by the user as desired. Based on this, it can be determined whether the obtained power power-on time parameter is among the predetermined power-on time periods, so as to determine the target type of the corresponding target electronic device. When the target power-on time parameter is the power-on start time, a kitchen ventilator may have predetermined power-on start time of 7:00 to 7:30, 11:00 to 11:30 and 17:30 to 18:00. Based on this, it can be determined whether the obtained power power-on time parameter is among the predetermined power-on start times, so as to determine the target type of the corresponding target electronic device.

It can be seen from the above example that, since different target electronic devices may have different target power-on time parameters, the target type of the target electronic device connected to the smart socket can be determined based on the target power-on time parameter.

In a fourth scheme, the target type corresponding to the target power-on time length parameter can be determined based on predetermined corresponding relationships between power-on time length parameters and respective electronic device types.

The target power-on state parameter is the target power-on time length parameter. The target power-on time length parameter indicates a total power-on time length of the target electronic device. For home appliances, different electrical devices may have different power-on time length parameters and the target electronic device can be determined based on its power-on time length. For example, a refrigerator is typically always in the power-on state. When the target electronic device is always in the power-on state, the target type can be determined as a refrigerator.

It can be seen from the above example that, since different target electronic devices may have different power-on time length parameters, the target type of the target electronic device connected to the smart socket can be determined based on the power-on time length parameter.

It can be appreciated that the above schemes can be combined, such that the target type of the target electronic device connected to the smart socket can be identified based on multiple target power-on state parameters, thereby improving the identification accuracy. In the following, some combinations will be explained by way of example.

In a first combination, the target type corresponding to the target electrical power parameter and the target power-on time parameter can be determined based on a predetermined third corresponding relationship table containing corresponding relationships among electrical power parameters, power-on time parameters and respective electronic device types.

The target power-on state parameter includes the target electrical power parameter and the target power-on time parameter. The third corresponding relationship table contains the corresponding relationships among the electrical power parameters, the power-on time parameters and the respective electronic device types. Once the electrical power parameter and the power-on time parameter have been determined, the target type of the target electronic device can be determined accordingly.

It can be seen from the above example that the target electronic device can be identified based not only on the fact that different target electronic devices have different electrical powers, but also on the fact that the different target electronic devices have different target power-on time parameters, thereby providing an improved identification accuracy. Particularly, when different target electronic devices have the same electrical power but different target power-on time parameters, or when different target electronic devices have the same target power-on time parameter but different target electrical power parameters, the target type corresponding to the target electrical power parameter and the target power-on time parameter can be determined based on the predetermined third corresponding relationship table.

In a second combination, the target electrical power parameter of the target electronic device connected to the smart socket and in the power-on state can be obtained during a predetermined time period. The electrical power stability parameter of the target electronic device can be determined based on the target electrical power parameter. The target type corresponding to the electrical power stability parameter and the target power-on time parameter can be determined based on a fourth corresponding relationship table containing corresponding relationships among electrical power stability parameters, target power-on time parameters and respective electronic device types.

The target power-on state parameter includes the electrical power stability parameter and the target power-on time parameter. The fourth corresponding relationship table contains the corresponding relationships among the electrical power stability parameters, the power-on time parameters and the respective electronic device types. Once the electrical power stability parameter and the power-on time parameter have been determined, the corresponding target type of the target electronic device can be determined accordingly.

In this example, the type of the target electronic device can be identified based on the electrical power stability parameter and the power-on time parameter, such that the identification accuracy can be further improved.

In a third combination, the target type corresponding to the target electrical power parameter and the target power-on time length parameter can be determined based on a predetermined fifth corresponding relationship table containing corresponding relationships among electrical power parameters, power-on time length parameters and respective electronic device types.

The target power-on state parameter includes the target electrical power parameter and the target power-on time length parameter. The fifth corresponding relationship table contains the corresponding relationships among the electrical power parameters, the power-on time length parameters and the respective electronic device types. Once the electrical power parameter and the power-on time length parameter have been determined, the corresponding target type of the target electronic device can be determined accordingly.

It can be seen from the above example that the target electronic device can be identified based not only on the fact that different target electronic devices have different electrical power parameters, but also on the fact that the different target electronic devices may have different target power-on time length parameters, thereby providing an improved identification accuracy. Particularly, when different target electronic devices have the same electrical power but different target power-on time length parameters, or when different target electronic devices have the same target power-on time length parameter but different target electrical power parameters, the target type corresponding to the target electrical power parameter and the target power-on time length parameter can be determined based on the predetermined fifth corresponding relationship table.

For the step 103, there are various schemes for outputting the target type, including e.g., visual output or audio output. On one hand, when there is a one-to-one corresponding relationship between the output position and the smart socket, the target type can be outputted directly. For example, the target type can be outputted via an output component provided in the smart socket, the output component being provided at a position corresponding to a connection position at which the target electronic device is connected to the smart socket. On the other hand, when the relationship between the output position and the smart socket is unknown, the corresponding relationship between the target type and the smart socket can still be outputted.

In an optional implementation, the step 103 may include: outputting prompt information for confirming the target type; detecting a confirmation instruction and a modification instruction for the prompt information; outputting the target type in response to detecting the confirmation instruction; and outputting a modified target type in response to detecting the modification instruction.

In order to avoid erroneous automatic identification of the target type of the target electronic device connected to the smart socket, prompt information can be outputted for confirming whether the target type is correct or not. FIG. 1F is a schematic diagram showing a prompt interface according to an example of the present disclosure. As shown in FIG. 1F, a prompt box can pop up on a screen to inform the user of the target type of the target electronic device connected to the smart socket, e.g., “The target electronic device corresponding to the smart socket is a refrigerator.” A “Confirm” button and a “Modify” button are also displayed for the user to confirm or modify the information. A confirmation instruction or a modification instruction is received on the interface where the prompt information is displayed. The target type can be outputted in response to the confirmation instruction, or a modified target type can be outputted in response to the modification instruction.

In the present disclosure, the target type of the target electronic device corresponding to the smart socket can be further confirmed by means of human-machine interaction. Further, when multiple target types are determined for one single receptacle in the step 102, a number of reference target types can be provided for selection by the user, so as to avoid waste of user's time spent in determining the type of the target electronic device from a large number of electronic devices.

Some application examples will be given herein for explanation. For example, when the server detects that a target electronic device connected to the receptacle has an electrical power of 3 W, is typically used in the night and has a stable power, the server can push “lamp” to the user for confirmation. When the server detects that a target electronic device connected to the receptacle has an electrical power of 150 W and operates constantly, the server can push “refrigerator” to the user for confirmation. When the server detects that a target electronic device connected to the receptacle has an electrical power of 1200 W and has a power that varies frequently over a certain range, the server can push “air conditioner” to the user for confirmation.

Correspondingly to the above examples of the method for identifying a type of an electronic device on a smart socket, examples of an apparatus for identifying a type of an electronic device on a smart socket and a terminal where the apparatus can be applied are also provided.

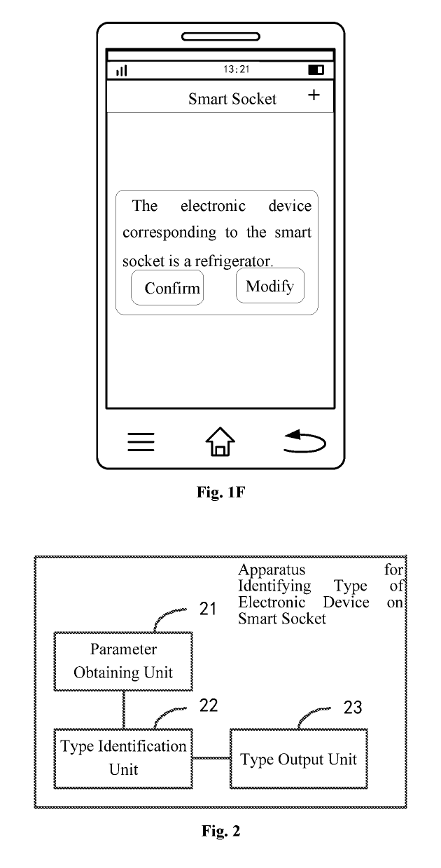

FIG. 2 is a block diagram of an apparatus for identifying a type of an electronic device on a smart socket according to an exemplary embodiment of the present disclosure. As shown in FIG. 2, the apparatus includes a parameter obtaining unit 21, a type identification unit 22 and a type output unit 23.

The parameter obtaining unit 21 is configured to obtain a target power-on state parameter of a target electronic device connected to the smart socket in a power-on state.

The type identification unit 22 is configured to identify a target type of the target electronic device based on the target power-on state parameter obtained by the parameter obtaining unit.

The type output unit 23 is configured to output the target type identified by the type identification unit.

In the above example, a target power-on state parameter of a target electronic device connected to the smart socket in a power-on state is obtained. A target type of the target electronic device is identified based on the target power-on state parameter. Then, the target type is outputted. In this way, a user can obtain a corresponding relationship between the smart socket and the target electronic device based on the outputted target type information and control the smart socket connected with the target electronic device based on the corresponding relationship, so as to avoid controlling a socket corresponding to another electronic device by mistake due to lack of knowledge about the corresponding relationship between the target electronic device and the smart socket.

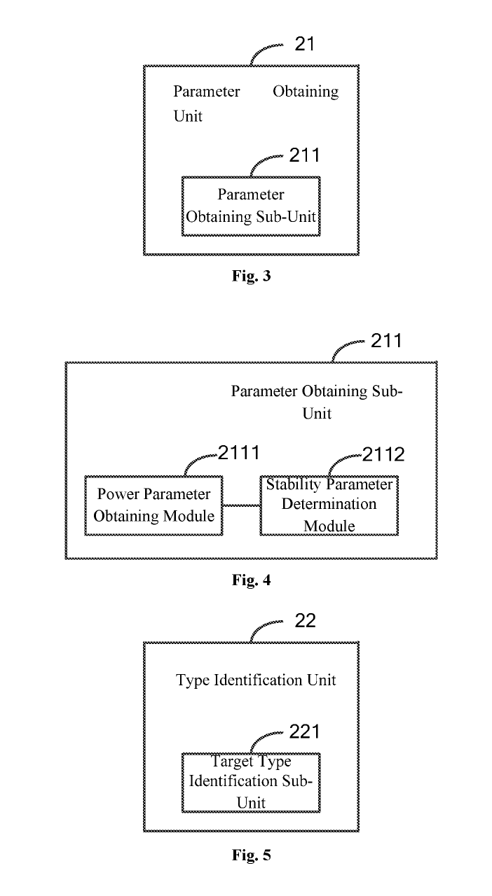

FIG. 3 is a block diagram of another apparatus for identifying a type of an electronic device on a smart socket according to an exemplary embodiment of the present disclosure. Further to the example shown in FIG. 2, in this example, the parameter obtaining unit 21 includes a parameter obtaining sub-unit 211.

The parameter obtaining sub-unit 211 is configured to obtain at least one of the following target power-on state parameters of the target electronic device connected to the smart socket and in the power-on state: a target electrical power parameter, a target power-on time parameter, a target power-on time length parameter and an electrical power stability parameter.

In the above example, the target power-on state parameter can be one or more of a target electrical power parameter, a target power-on time parameter, a target power-on time length parameter and an electrical power stability parameter. The target type of the target electronic device corresponding to the smart socket can be identified automatically depending on different target power-on state parameters, so as to identify the target electronic device. The accuracy of identification can be improved when various parameters are used in combination for identification.

FIG. 4 is a block diagram of another apparatus for identifying a type of an electronic device on a smart socket according to an exemplary embodiment of the present disclosure. Further to the example shown in FIG. 3, in this example, the parameter obtaining sub-unit 211 includes a power parameter obtaining module 2111 and a stability parameter determination module 2112.

The power parameter obtaining module 2111 is configured to obtain the target electrical power parameter of the target electronic device connected to the smart socket and in the power-on state during a predetermined time period.

The stability parameter determination module 2112 is configured to determine the electrical power stability parameter of the target electronic device based on the target electrical power parameter obtained by the power parameter obtaining module.

In the above example, the target electrical power parameter of the target electronic device connected to the smart socket in the power-on state can be obtained during a predetermined time period. The electrical power stability parameter of the target electronic device can be determined based on the target electrical power parameter.

FIG. 5 is a block diagram of another apparatus for identifying a type of an electronic device on a smart socket according to an exemplary embodiment of the present disclosure. Further to the example shown in FIG. 2, in this example, the type identification unit 22 includes a target type identification sub-unit 221.

The target type identification sub-unit 221 is configured to determine the target type corresponding to the target power-on state parameter obtained by the parameter obtaining unit based on a target corresponding relationship table containing corresponding relationships between power-on state parameters and respective electronic device types.

In the above example, the target type corresponding to the target power-on state parameter can be determined based on predetermined corresponding relationships between power-on state parameters and respective electronic device types.

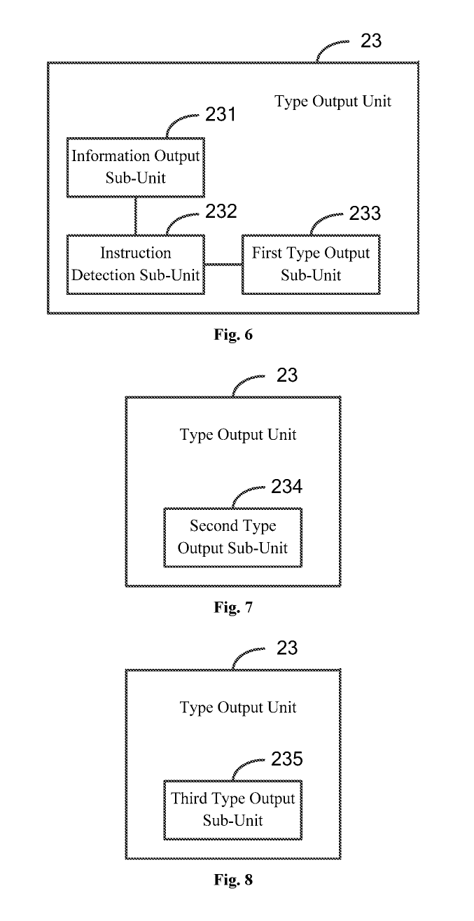

FIG. 6 is a block diagram of another apparatus for identifying a type of an electronic device on a smart socket according to an exemplary embodiment of the present disclosure. Further to the example shown in FIG. 2, in this example, the type output unit 23 includes an information output sub-unit 231, an instruction detection sub-unit 232 and a first type output sub-unit 233.

The information output sub-unit 231 is configured to output prompt information for confirming the target type identified by the type identification unit.

The instruction detection sub-unit 232 is configured to detect a confirmation instruction and a modification instruction for the prompt information output by the information output sub-unit.

The first type output sub-unit 233 is configured to output the target type when the confirmation instruction is detected or to output a modified target type when the modification instruction is detected.

In the above example, the target type of the target electronic device corresponding to the smart socket can be further confirmed by means of human-machine interaction. In this way, it is possible to improve the accuracy of the identification and avoid erroneous automatic identification of the target type.

FIG. 7 is a block diagram of another apparatus for identifying a type of an electronic device on a smart socket according to an exemplary embodiment of the present disclosure. Further to the example shown in FIG. 2, in this example, the type output unit 23 includes a second type output sub-unit 234.

The second type output sub-unit 234 is configured to output the target type identified by the type identification unit via an output component provided in the smart socket. The output component is provided at a position corresponding to a connection position at which the target electronic device is connected to the smart socket.

In the above example, since there are one-to-one corresponding relationships between the positions of the output components and the connection positions, the target type outputted by an output component of the smart socket shows the corresponding relationship between the target type and a receptacle in the smart socket, making it convenient for the user to operate the smart socket.

FIG. 8 is a block diagram of another apparatus for identifying a type of an electronic device on a smart socket according to an exemplary embodiment of the present disclosure. Further to the example shown in FIG. 2, in this example, the type output unit 23 includes a third type output sub-unit 235.

The third type output sub-unit 235 is configured to output the target type identified by the type identification unit via a smart device that is a control terminal of the smart socket.

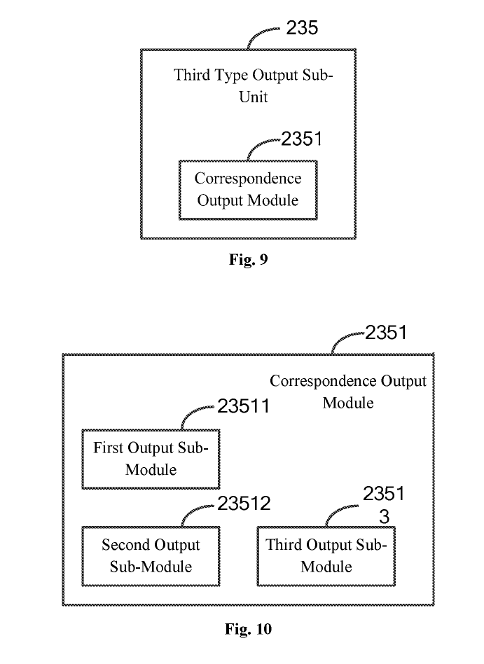

FIG. 9 is a block diagram of another apparatus for identifying a type of an electronic device on a smart socket according to an exemplary embodiment of the present disclosure. Further to the example shown in FIG. 8, in this example, the third type output sub-unit 235 includes a corresponding relationship output module 2351.

The corresponding relationship output module 2351 is configured to control the smart device to output a corresponding relationship between the target type and the smart socket.

In the above example, a smart device can output the corresponding relationship between the target type and the smart socket, which shows the corresponding relationship between the target type and a receptacle in the smart socket. This is convenient for the user to control the smart socket using the smart device.

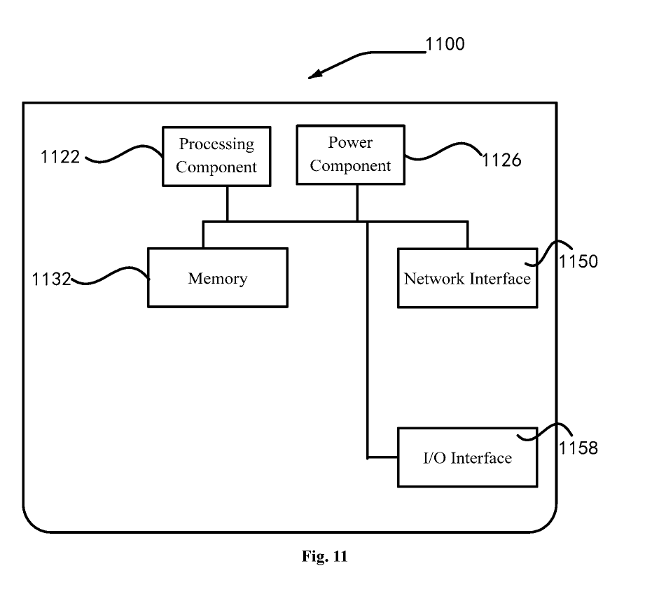

FIG. 10 is a block diagram of another apparatus for identifying a type of an electronic device on a smart socket according to an exemplary embodiment of the present disclosure. Further to the example shown in FIG. 9, in this example, the corresponding relationship output module 2351 includes at least one of the following sub-modules. For the purpose of clear illustration, FIG. 10 shows all sub-modules that can be included in the corresponding relationship output module 2351: a first output sub-module 23511, a second output sub-module 23512 and a third output sub-module 23513.

The first output sub-module 23511 is configured to control the smart device to output the target type in accordance with a positional rank of the electronic device on the smart socket.

The second output sub-module 23512 is configured to control the smart device to output the target type at a corresponding position on a virtual socket image, which is a virtual image of the smart socket generated by the smart device.

The third output sub-module 23513 is configured to control the smart device to output the target type at a name position corresponding to the smart socket.

In the present disclosure, the smart device can output the target type in accordance with a positional rank of the electronic device on the smart socket. In this way, the corresponding relationship between a receptacle and the target type can be obtained and the user can control the smart socket connected with the target electronic device based on the corresponding relationship, thereby avoiding the case where the plug for the target electronic device cannot be identified when a number of target electronic devices are connected to the socket. In the present disclosure, the smart device can output the target type at a corresponding position on a virtual socket image. In this way, the corresponding relationship between the target type and a receptacle in the smart socket can be shown, making it convenient for the user to control the smart socket using the smart device.

In the present disclosure, once the type of the target electronic device connected to the smart socket has been identified, the target type can be automatically outputted at a name position corresponding to the smart socket by the smart device. In this way, it is possible to name the smart socket with an improved naming efficiency. Meanwhile, it is convenient for the user to distinguish between different electronic devices connected to different smart sockets based on the names.

An apparatus for identifying a type of an electronic device on a smart socket is also provided. The apparatus includes a processor and a memory storing instructions executable by the processor. The processor is configured to: obtain a target power-on state parameter of a target electronic device connected to the smart socket in a power-on state; identify a target type of the target electronic device based on the target power-on state parameter; and output the target type.

For the implementation of the functions of the respective units in the above apparatus, reference can be made to the implementation of the corresponding steps in the above method and the details thereof will be omitted here.

For the apparatus example, reference can be made to the corresponding description of the method example since it substantially corresponds to the method example. The apparatus example as described above is illustrative only. Those units described as discrete components may or may not be physically separated. Those components shown as units may or may not be physical units, i.e., they can either be co-located, or distributed over a number of network elements. Some or all of the modules can be selected as desired to achieve the object of the present disclosure, as can be understood and implemented by those skilled in the art without any inventive efforts.

The module, sub-module, unit and sub-unit disclose herein may have at least one processor and a memory that is communicably connected with the at least one processor for storing instructions executable by the at least one processor.

FIG. 11 is a block diagram of an apparatus 1100 for identifying a type of an electronic device on a smart socket according to an exemplary embodiment of the present disclosure. As shown in FIG. 11, the apparatus 1100 can be provided as e.g., a server. Referring to FIG. 11, the apparatus 1100 includes: a processing component 1122, which further includes one or more processors; and storage resources represented by a memory 1132, for storing instructions, i.e., applications, executable by the processing component 1122. The applications stored in the memory 1132 may include one or more modules each corresponding to a set of instructions. Further, the processing component 1122 is configured to execute instructions to perform the above method for identifying a type of an electronic device on a smart socket.

The apparatus 1100 can further include: a power component 1126 configured to perform power management for the apparatus 1100, a wired or wireless network interface 1150 configured to connect the apparatus 1100 to a network, and an input/output (TO) interface 1158. The apparatus 1100 can operate based on an operating system stored in the memory 1132, e.g., Windows Server™, MAC OS X™, Unix™, Linux™, FreeBSD™, or the like.

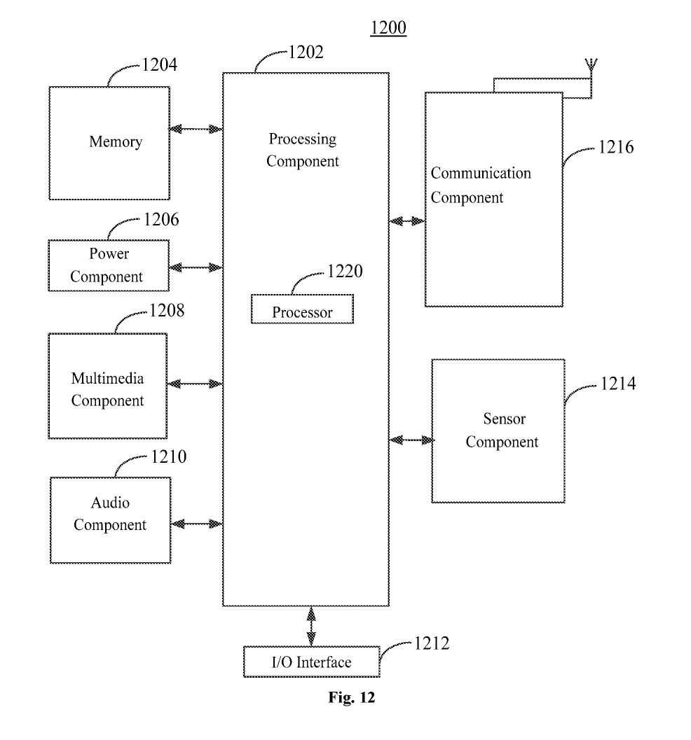

FIG. 12 is a block diagram showing another apparatus 1200 for identifying a type of an electronic device on a smart socket according to an exemplary embodiment. For example, the apparatus 1200 may be a mobile phone with a routing function, a computer, a digital broadcast terminal, a messaging device, a gaming console, a tablet, a medical device, exercise equipment, a personal digital assistant or the like.

Referring to FIG. 12, the apparatus 1200 may include one or more of the following components: a processing component 1202, a memory 1204, a power supply component 1206, a multimedia component 1208, an audio component 1210, an input/output (I/O) interface 1212, a sensor component 1214 and a communication component 1216.

The processing component 1202 generally controls the overall operations of the apparatus 1200, for example, display, phone call, data communication, camera operation and record operation. The processing component 1202 may include one or more processors 1220 to execute instructions to perform all or part of the steps in the above described methods. In addition, the processing component 1202 may include one or more modules to facilitate the interaction between the processing component 1202 and other components. For example, the processing component 1202 may include a multimedia module to facilitate the interaction between the processing component 1208 and the processing component 1202.

The memory 1204 is configured to store various types of data to support the operation performed on the apparatus 1200. Examples of such data include instructions for any applications or methods operated on the apparatus 1200, contact data, phonebook data, messages, pictures, video, etc. The memory 1204 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 1206 provides power to various components of the apparatus 1200. The power supply component 1206 may include a power supply management system, one or more power sources, and any other components associated with the generation, management, and distribution of power in the apparatus 1200.

The multimedia component 1208 includes a screen providing an output interface between the apparatus 1200 and the user. In some examples, the screen may include a Liquid Crystal Display (LCD) and a Touch Panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some examples, the multimedia component 1208 includes a front camera and/or a rear camera. The front camera and the rear camera may receive external multimedia data while the apparatus 1200 is in an operation mode, such as a photographing mode or a video mode. Each of the front camera and the rear camera may be a fixed optical lens system or have focus and optical zoom capability.

The audio component 1210 is configured to output and/or input audio signals. For example, the audio component 1210 includes a microphone (“MIC”) configured to receive an external audio signal when the apparatus 1200 is in an operation mode, such as a call mode, a recording mode, and a voice recognition mode. The received audio signal may be further stored in the memory 1204 or transmitted via the communication component 1216. In some examples, the audio component 1210 further includes a speaker to output audio signals.

The I/O interface 1212 provides an interface between the processing component 1202 and peripheral interface modules, such as a keyboard, a click wheel, buttons, and the like. The buttons may include, but are not limited to, a home button, a volume button, a starting button, and a locking button.

The sensor component 1214 includes one or more sensors to provide status assessments of various aspects of the apparatus 1200. For instance, the sensor component 1214 may detect an open/closed status of the apparatus 1200, relative positioning of components, e.g., the display and the keypad, of the apparatus 1200, a change in position of the apparatus 1200 or a component of the apparatus 1200, a presence or absence of user contact with the apparatus 1200, an orientation or an acceleration/deceleration of the apparatus 1200, and a change in temperature of the apparatus 1200. The sensor component 1214 may include a proximity sensor configured to detect the presence of nearby objects without any physical contact. The sensor component 1214 may also include a light sensor, such as a CMOS or CCD image sensor, for use in imaging applications. In some examples, the sensor component 1214 may also include an accelerometer sensor, a gyroscope sensor, a magnetic sensor, a pressure sensor, a microwave sensor or a temperature sensor.

The communication component 1216 is configured to facilitate wired or wireless communication between the apparatus 1200 and other devices. The apparatus 1200 can access a wireless network based on a communication standard, such as WiFi, 2G or 3G or a combination thereof. In one exemplary embodiment, the communication component 1216 receives a broadcast signal or broadcast related information from an external broadcast management system via a broadcast channel. In one exemplary embodiment, the communication component 1216 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1204, executable by the processor 1220 of the apparatus 1200, for performing the above-described methods. For example, the non-transitory computer-readable storage medium may be a ROM, a RAM, a CD-ROM, a magnetic tape, a floppy disc, an optical data storage device, and the like.

When executed by the processor of a terminal, the instructions in the non-transitory computer-readable storage medium cause the terminal to perform a method for identifying a type of an electronic device on a smart socket. The method comprises: obtaining a target power-on state parameter of a target electronic device connected to the smart socket in a power-on state; identifying a target type of the target electronic device based on the target power-on state parameter; and outputting the target type.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors.

Other examples of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the appended claims.

It will be appreciated that the present disclosure is not limited to the exact construction that has been described above and illustrated in the accompanying drawings, and that various modifications and changes can be made without departing from the scope thereof It is intended that the scope of the disclosure only be limited by the appended claims.

The aforementioned examples are just preferred examples of the present disclosure, and are not intended to limit the present disclosure. Any modifications, equivalent substitutions and improvements made under the spirits and principles of the present disclosure are intended to fall within the protection scope of the present disclosure.

What is claimed is:

1. A method for identifying a type of an electronic device on a smart socket, comprising:
obtaining a target power-on state parameter of a target electronic device connected to the smart socket in a power-on state;
identifying a target type of the target electronic device based on the target power-on state parameter; and
outputting the target type.

2. The method of claim 1, wherein obtaining the target power-on state parameter further comprises:
obtaining at least one of the following target power-on state parameters of the target electronic device connected to the smart socket in the power-on state: a target electrical power parameter, a target power-on time parameter, a target power-on time length parameter and an electrical power stability parameter.

3. The method of claim 2, wherein obtaining the electrical power stability parameter further comprises:
obtaining, during a predetermined time period, the target electrical power parameter of the target electronic device connected to the smart socket in the power-on state; and
determining the electrical power stability parameter of the target electronic device based on the target electrical power parameter.

4. The method of claim 1, wherein identifying the target type of the target electronic device further comprises:
determining a target type corresponding to the target power-on state parameter based on a target corresponding relationship table, the target corresponding relationship table containing corresponding relationships between power-on state parameters and respective electronic device types.

5. The method of claim 1, wherein outputting the target type further comprises:
outputting prompt information for confirming the target type;
detecting a confirmation instruction and a modification instruction for the prompt information;
outputting the target type in response to detecting the confirmation instruction; and
outputting a modified target type in response to detecting the modification instruction.

6. The method of claim 1, wherein outputting the target type further comprises:
outputting the target type via an output component provided in the smart socket, the output component being provided at a position corresponding to a connection position at which the target electronic device is connected to the smart socket.

7. The method of claim 1, wherein outputting the target type further comprises:
outputting the target type via a smart device, the smart device being a control terminal of the smart socket.

8. The method of claim 7, wherein outputting the target type via the smart device comprises:
controlling the smart device to output a corresponding relationship between the target type and the smart socket.

9. The method of claim 8, wherein controlling the smart device comprises at least one of:
controlling the smart device to output the target type in accordance with a positional rank of the electronic device on the smart socket;
controlling the smart device to output the target type at a corresponding position on a virtual socket image, wherein the virtual socket image is a virtual image of the smart socket generated by the smart device; and
controlling the smart device to output the target type at a name position corresponding to the smart socket.

10. An apparatus for identifying a type of an electronic device on a smart socket, comprising:
a processor; and
a memory storing instructions executable by the processor,
wherein the processor is configured to:
obtain a target power-on state parameter of a target electronic device connected to the smart socket in a power-on state;
identify a target type of the target electronic device based on the target power-on state parameter; and
output the target type.

11. The apparatus of claim 10, wherein the processor is further configured to:
obtain at least one of the following target power-on state parameters of the target electronic device connected to the smart socket in the power-on state: a target electrical power parameter, a target power-on time parameter, a target power-on time length parameter and an electrical power stability parameter.

12. The apparatus of claim 11, wherein the processor is further configured to:
obtain, during a predetermined time period, the target electrical power parameter of the target electronic device connected to the smart socket in the power-on state; and
determine the electrical power stability parameter of the target electronic device based on the target electrical power parameter.

13. The apparatus of claim 10, wherein the processor is further configured to:
determine a target type corresponding to the target power-on state parameter based on a target corresponding relationship table, the target corresponding relationship table containing corresponding relationships between power-on state parameters and respective electronic device types.

14. The apparatus of claim 10, wherein the processor is further configured to:
output prompt information for confirming the target type;
detect a confirmation instruction and a modification instruction for the prompt information;
output the target type in response to detecting the confirmation instruction; and
output a modified target type in response to detecting the modification instruction.

15. The apparatus of claim 10, wherein the processor is further configured to:
output the target type via an output component provided in the smart socket, the output component being provided at a position corresponding to a connection position at which the target electronic device is connected to the smart socket.

16. The apparatus of claim 10, wherein the processor is further configured to:
output the target type via a smart device, the smart device being a control terminal of the smart socket.

17. The apparatus of claim 16, wherein the processor is further configured to:
control the smart device to output a corresponding relationship between the target type and the smart socket.

18. The apparatus of claim 17, wherein the processor is further configured to:
control the smart device to output the target type in accordance with a positional rank of the electronic device on the smart socket; or
control the smart device to output the target type at a corresponding position on a virtual socket image, wherein the virtual socket image is a virtual image of the smart socket generated by the smart device; or
control the smart device to output the target type at a name position corresponding to the smart socket.

19. A non-transitory computer-readable storage medium having instructions stored therein for identifying a type of an electronic device on a smart socket, wherein the instructions, when executed by a processor of a mobile terminal, cause the mobile terminal to:
obtain a target power-on state parameter of a target electronic device connected to the smart socket in a power-on state;
identify a target type of the target electronic device based on the target power-on state parameter; and
output the target type.

20. The storage medium of claim 19, wherein the instructions to obtain the target power-on state parameter, further cause the processor to:
obtain at least one of the following target power-on state parameters of the target electronic device connected to the smart socket in the power-on state: a target electrical power parameter, a target power-on time parameter, a target power-on time length parameter and an electrical power stability parameter.
